(19) United States
(12) Patent Application Publication
(10) Pub. No.: US 2004/0213981 A1
(43) Pub. Date: Oct. 28, 2004

(54) Stretched and voided polymeric film

(76) Inventors: Graham Clark, Brussels (BE); Jonathan Hewitt, Cumbria (GB)

Correspondence Address: WENDEROTH, LIND & PONACK, L.L.P., 2033 K STREET N. W., SUITE 800, WASHINGTON, DC, 20006-1021, US

(21) Appl. No.: 10/488,707

(22) PCT Filed: Oct. 15, 2002
(86) PCT No.: PCT/EP02/11510

(30) Foreign Application Priority Data
Oct. 15, 2001 (GB) 0124659.4

(51) Int. Cl. B32B 3/26

(52) U.S. Cl. 428/304.4; 428/327

(57) ABSTRACT

There is described a simultaneously oriented polyolefinic (e.g. polypropylene) film comprising particles in at least one layer thereof, said particles incompatible with said layer to cause the initiation of voids therein when the cast polyolefin is stretched simultaneously in both the MD and TD, and where the particles comprise: (i) particles having a mean aspect ratio x/y of at least 2 (e.g. long and thin) and a mean size of the longest particle dimension greater than about 3 microns (preferably about 6 microns); and/or (ii) particles having a mean aspect ratio of about 1 (e.g. spherical or boulder-like), with a narrow size distribution, a mean particle size of from about 3 to about 10 microns, (preferably about 6 microns), and which are substantially free of particles above about 12 microns in size and optionally also substantially free of particles below about 3 microns in size. Preferred BOPP films are further characterised in that ratio of at least one of the following properties measured in the MD with respect to TD is: (a) tensile strength of above 0.5; (b) elongation at break of below 2.0; (c) Young's modulus of at least 0.7; and/or (d) shrinkage of at least 0.45, the TD shrinkage being other than zero.

This invention relates to the production of opaque, voided, oriented polymeric film (such as polyolefinic film, e.g. BOPP film) prepared using a simultaneous draw process.

Stenter polypropylene processors have long been able to produce voided film by the use of mineral fillers such as calcium carbonate in fine particulate form. Experience has shown that the production of a voided polypropylene film has not been possible with these materials using a simultaneous draw process. The inability to produce stable films by these methods is due to the differences in process conditions between a simultaneous draw process and a sequential draw process.

In a sequential draw process the polypropylene cast sheet is first drawn at a relatively low temperature (110 to 130° C.) in the forward direction. This process initiates the void formation by relatively small particles below 1 micron. The forward drawn cast sheet is then drawn at a higher temperature (150 to 160° C.) in the transverse direction. This causes the growth of the voids which were initiated in the forward draw. In a simultaneous process the forward draw and transverse draw are performed at the same time. This process is performed at a higher temperature (typically 150 to 160° C.). At higher temperature larger particles, above 3 to 5 micron in size, are required to initiate void formation. These large particles then adversely affect the stability of the process. This invention describes methods of producing voided film using a stable simultaneous process.

Voided films produced by sequential orientation are well known. For example:

U.S. Pat. No. 4,377,616 (Mobil Oil Corporation) describes a method of production of a voided film using spherical void initiating particles. The particles can be organic, inorganic or polymeric in nature. Each void has at least one particle which caused its initiation.

Cross-linked polystyrene micro-spheres have also been used to produce voided BOPP film by sequential orientation on a conventional stenter machine.

The use of inorganic fillers such as calcium carbonate for the production of voided film on a stenter process where the film is sequentially oriented has long been known.

There are many other patents which describe applications of voided opaque film by a sequential orientation process.

Production of simultaneously biaxially oriented voided film has been attempted using the above methods but has proved to be unsuccessful. The applicant has found that mineral filler particles with diameters above 2 to 3 micron are required before voiding can be observed in a simultaneous process such as those described above and such large particles adversely effect the stability of the process.

In a non-simultaneous process the cast film sheet can be stretched in the forward direction at relatively low temperatures. This initial low temperature draw initiates the formation of voids. The forward drawn cast sheet is then drawn in the transverse direction at a higher temperature. During the transverse draw the already initiated voids grow in size to give the opaque/opalescent effect characteristic of voided films. In a simultaneous draw process the film is drawn at a temperature closer to the second draw process in the non-simultaneous process. This has to be overcome by including larger void initiating particles into the film than are required with a non-simultaneous process. These larger particles then lead to a reduction in process stability.

Thus it is an object of the present invention to solve some or all of the problems identified with prior art voided films and/or processes for making them.

Therefore broadly in accordance with the present invention there is provided a simultaneously oriented polyolefinic (e.g. polypropylene) film comprising particles in at least one layer thereof, said particles incompatible with said layer to cause the initiation of voids therein when the cast polyolefin is stretched simultaneously in both the MD and TD, and where the particles comprise:

(i) particles having a mean aspect ratio x/y of at least 2 (e.g. long and thin) and a mean size of the longest particle dimension greater than about 3 microns (preferably about 6 microns); and/or

(ii) particles having a mean aspect ratio of about 1 (e.g. spherical or boulder-like), with a narrow size distribution, a mean particle size of from about 3 to about 10 microns, (preferably about 6 microns), and which are substantially free of particles above about 12 microns in size and optionally also substantially free of particles below about 3 microns in size.

Optionally the particles are present in an amount from about 5% to about 40% by weight of said layer.

Preferably films of the invention are further characterised in that ratio of at least one of the following properties measured in the MD with respect to TD is: (a) tensile strength of above 0.5; (b) elongation at break of below 2.0; (c) Young's modulus of at least 0.7; and/or (d) shrinkage of at least 0.45,. the TD shrinkage being other than zero.

In yet further aspects of the present invention there are provided one or more methods, films, processes and/or uses as described herein and/or in the independent claims herein. Further preferred features of the invention are described herein and/or in the dependent claims herein.

The present invention may use micro-platelet type fillers to initiate the formation of voids in the simultaneous process. As these materials are significantly larger in the x and y directions than in the z direction they align with the plane of the film as the film is oriented. The result is that particles large enough to cause voiding can be included in the film. As the particles are aligned in the plane of the film with the shortest axis of the particle at 900 to the plane of the film process stability is maintained.

This invention relies on the use of certain voiding agents to achieve a stable process for the production of voided simultaneously drawn biaxially oriented film. The technique uses a group of voiding agents with specific geometries. For example the applicant has surprisingly discovered that if the voiding agent comprises long thin particles (high aspect ratio) the stability issues seen in prior art simultaneously oriented voided films can be reduced. Alternatively the applicant has found that if low aspect ratio particles (e.g. spherical or irregular boulder-like particles) are used as the voiding agents, then if the particles used also have a narrow particle size distribution (i.e. are substantially free of small (e.g. less than 3 micron) and/or large (e.g. greater than 12 micron) particles) the stability problems of simultaneously oriented voided films may also be reduced.

As used herein x direction denotes an axis parallel to the MD of the film; y direction denotes an axis parallel to the TD of the film; and z direction denotes an axis perpendicular to the plane of the film (i.e. across the gauge of the film web).

Flat platelet materials can be used as voiding agents. The flat platelets can be relatively large in the x and y direction but the z direction is much smaller typically 0.5 or less of the x and y dimensions. In other words the platelets have a large aspect ratio x/z or y/z. When the film is drawn the flat platelets orient in the plane of the film and so do not reduce the overall stability of the process. Typical examples of these materials would be fine powdered mica; calcium carbonate; any other mineral powder with a high aspect ratio; powders of polymers incompatible with that of the polymeric film (such as thin polyester acrylic or nylon films): glass particles with high aspect ratios; metallic pigments which comprise particles of metal with high aspect ratios; and/or any suitable mixtures and combinations thereof.

At the moment there are no methods of producing voided polypropylene film in a simultaneous draw process which produce films with the desired properties to be commercially acceptable.

Films of the present invention prepared using for example the voiding agents described herein allow voided film to be produced on a simultaneous process such as a double bubble process and/or a simultaneous stenter process. The voiding agents used herein are relatively cheap and lead to an economically priced voided film.

Where high opacity voided film is required titanium dioxide powder or other finely ground mineral fillers can be added. The combination of voiding and opacifying agents leads to a film with higher opacity than can be achieved using either of these techniques alone. This technique can be used to good effect with the present class of voiding agents.

Layered structures can be produced in which the voided polypropylene can be contained in any of the layers in the structure. Heat sealable melt coats can be applied to voided core materials. Pigments or dyes can be incorporated in to the structure to produce coloured voided film. Use of metallic voiding agents can give a metallic effect voided film. When metallic platelet particles are used the particles orient in the plane of the film and give an enhanced metallic effect. The voided film can also be incorporated in laminated structures either laminated in-line on a bubble unit or laminated off line in a separate conversion process. The thickness of the film can be from 10 to 100 micron on a single ply film and from 20 to 200 micron on a laminated film where the lamination operation ids performed in-line. The thickness can be extended up to 150 micron for a single thickness film and 300 micron for a laminated film by the use of intermediate draw ratios.

The voiding agents can be incorporated into the polypropylene and film produced without drastically altering the process conditions away from standard operating conditions.

Films of the present invention can be produced by methods and/or properties which have been unavailable up to the present time. Films of the present invention can be used to make materials such as synthetic papers, increased opacity base film for use in coatings to extend the range of coated films and/or to produce opaque shrinkable films. The voided base film can also be converted in numerous ways to produce new novel effect films.

Preferred films of the invention are a voided simultaneously oriented polypropylene film with balanced properties. Optionally the film comprises a hard resin core. The film may be heat set if an opaque film is desired or not heat set if a shrinkable film is desired.

Preferably the film contains particles which are incompatible with the polypropylene and cause the initiation and growth of voids in the film when the cast polypropylene is stretched.

Other preferred film properties comprise: a film density lower than that of non-voided polypropylene film, more preferably less than 0.85 g/cm³; a ratio of shrinkage of the film MD/TD is less than 1, preferably about 0.5 for non-heat set film and greater than 1 for a heat set film; a film thickness from about 25 to about 40 micron, for example about 33 microns (or from about 25 micron for a single ply film to 300 micron for a thick laminated film); tensile strength of the film MD/TD is greater than about 0.5, optionally greater than about 1, (more preferably from about 1.0 to about 1.5 in the case of a heat set film); and/or elongation to break of the film MD/TD is less than about 1, (more preferably from about 0.5 to about 0.9 in the case of a heat set film).

For all ratios of the shrinkage of MD/TD are calculated assuming that the TD shrinkage is not zero. For the films of the present invention where TD shrinkage is zero a MD/TD ratio is not measured.

For comparison tensile strength ratios MD/TD for a sequentially drawn stenter film lie around 0.3 to 0.5. This compares to simultaneously drawn voided films of the invention (made using a bubble of LISM process) where the tensile strength ratios MD/TD lie above 0.5, preferably 0.9 to 1.5.

Films of the invention can contain TiO₂ to give enhanced whiteness and higher opacity and the opacity of the film may be higher than that of clear base film. Film of the invention can comprise white TiO₂-containing coats and/or sealable melt coats. Optionally the opacity of the film is higher than that film containing TiO₂ or voiding agent alone. Preferably the TiO₂ is present in the film in an amount of greater than about 5%, for example from about 9% to about 10% by weight.

The voiding agents which may be used in films of the invention may be characterised by shape such as: solid particles of material which are spherical in nature; particles of high aspect ratio i.e. platelet type materials; and/or voiding agents made up from irregular particles. The surface of the film can be textured or smooth. The amount of texturing can be controlled by the amount of TiO₂ and voiding agent added and by the processing conditions.

Lower draw ratios can be used to increase film thickness. The film can be on-line laminated to double the thickness of the single web.

Film can be used as a high opacity base film for applications such as synthetic papers, labels and the like.

Coat polymers can be added to the film surface such as polyethylene, polypropylene, copolymers of propylene and ethylene or terpolymers of propylene, ethylene, butylene. The coat polymers can be filled with mineral fillers to give higher opacity surface texture or higher degree of whiteness.

The process used to simultaneously oriented the film is optionally a double bubble process. The draw ratio in the standard process is 8 times in machine direction and 8 times in transverse direction. Intermediate draw ratios can also be used or low draw ratios can be used, for example where very thick film is required.

Specific examples of platelet type voiding agents comprise: mica powder, for example having a particle size up to about 40 micron in the x and y directions; metallic pigments (e.g. to give a metallic effect voided film.)

Further aspects, embodiments and preferred features of the invention are described in the claims.

The invention will now be illustrated by the following figures in which:

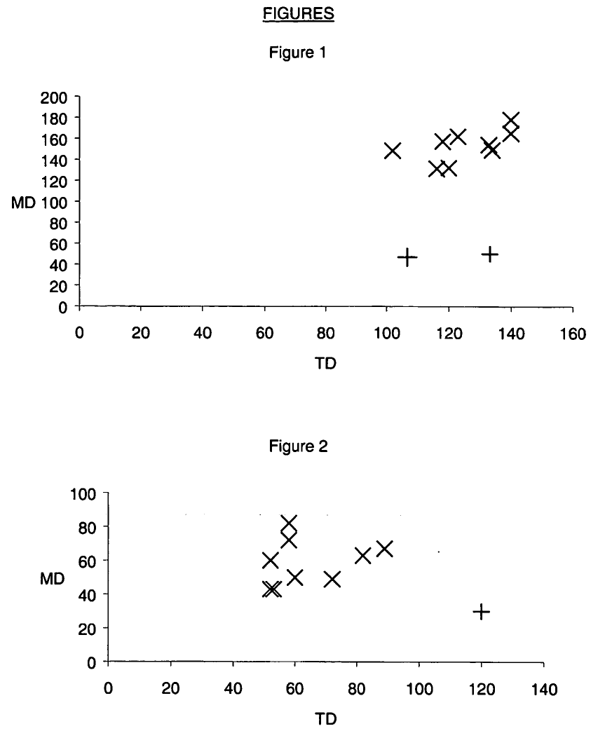

FIGS. 1 to 3 are plots of the MD versus TD for various properties of voided films made according to the invention by simultaneous orientation on a bubble compared to the same properties for prior art known films made by sequential orientation where “X” denotes a voided simultaneously oriented BOPP film of the invention and “+” denotes known voided sequentially oriented BOPP films.

FIG. 1 is a plot of MD/TD ratio for tensile strength;

FIG. 2 is a plot of MD/TD ratio for elongation at break/%; and

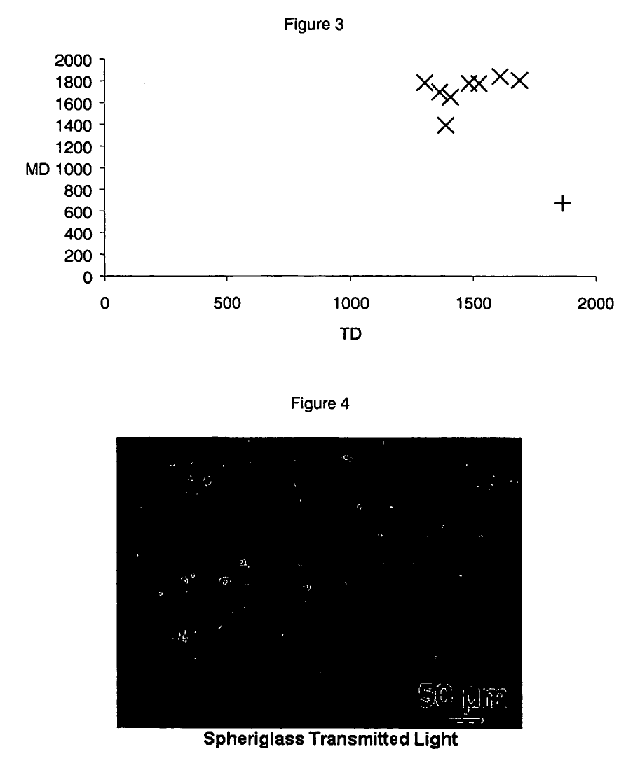

FIG. 3 is a plot of MD/TD ratio for Young's modulus.

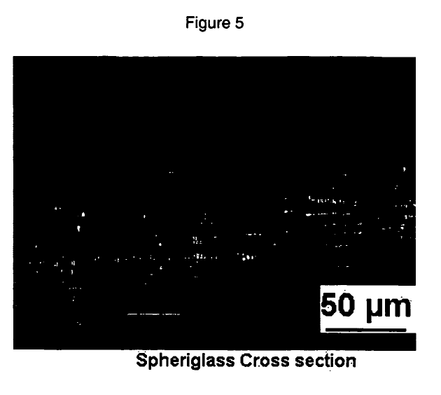

FIGS. 4 and 5 are photographs of a film of the invention made according to Example 14 herein, where the photographs are taken in transmitted light through the film and as a cross section in reflected light respectively.

From FIG. 1 it can be seen that for a sequentially stentered voided film the tensile strength MD/TD ratio lies around 0.3 to 0.5 whereas for the voided bubble film of the invention the tensile strength MD/TD ratio lies above 0.5, and typically from 0.9 to 1.5.

From FIG. 2 it can be seen that for a sequentially stentered voided film the elongation at break MD/TD ratio lies around 4.0 whereas for the voided bubble film of the invention the elongation at break MD/TD ratio lies below 4.0, and typically from 0.5 to 1.5.

From FIG. 3 it can be seen that for a sequentially stentered voided film the Young's modulus MD/TD ratio lies around 0.3 to 0.6, whereas for the voided bubble film of the invention the Young's modulus MD/TD ratio lies above 0.7.

From FIGS. 4 and 5 it can be seen that the shape of the voids are spherical when viewed from above. This fact leads to a high degree of balance in all directions.

Thus the balance of properties for films of the present invention leads to advantages such as ease of machineability and the ability to cut the film easily in any direction.

The present invention will be further illustrated by the following non-limiting examples.

The following materials were used in the Examples:

Spheriglass, which consists of micro-spherical glass beads with particle diameters down to 1 micron or less and aspect ratio around 1. A master batch of this material was made up by compounding it at 50 wt % in polypropylene using a twin screw extruder.

Silberline which consists of fine platelet like particles of aluminium available commercially from Silberline under the trade designations ET2025 and ST 210-30-El which align in the film during orientation and act to obscure the light passing through the film. This material was compounded at a 1:2 ratio into polypropylene using a single screw extruder. It has an aspect ratio greater than 1.

Mica powder available commercially from Microfine under the trade names Mica SX800 or Ultracarb U5 and which consists of platelet like particles that align themselves in the film and reflect light. The mica contained the largest particles with particles present up to 20 micron in diameter. The mica particles have an aspect ratio of about 8 so although the maximum diameter of the particles was 20 micron they were only 2 to 3 micron thick. Mica grades with smaller particle size would lead to increased stability. When the mica was used in the coat layer a large degree of die drools were observed.

Calcium carbonate master batches were available under the trade designations Pearl 2 with very fine (average 0.5 μm) particles; and Pearl 70 and Omyalene with larger (average 3 μm) particles. The aspect ratio of calcium carbonate particles is low. Particle size may affect the voiding efficiency to result in different results form each of these materials.

Hard resins which can be used are: a Mixed monomer hydrogenated resin made from α-methyl styrene, vinyl toluene and indene; a natural polyterpene; and/or a hydrogenated di-cyclopentadiene.

### EXAMPLES 1A TO 1C

(Mica Voiding Agent)

A master batch was made up containing 50% Mica SX800 and 50% polypropylene. This master-batch was then mixed with polypropylene at a number of different levels giving Mica levels of 10%, 15% and 20%. These mixtures were then pressed to form plaques using a hot press and picture frame mould. After quenching the plaques were removed and cut into squares 6 cm×6 cm. These squares of pressed material were then stretched on a simultaneous stretching at temperatures of 160° C., 155° C. and 150° C. (respectively). The resulting films were voided and opaque and had a reflective almost metallic appearance.

### EXAMPLES 2A TO 2C

(Mica Voiding Agent with White Pigment)

The same procedure was followed as above but this time 10% of white titanium dioxide was added as well as the 10,15 and 20% mica (Examples 2A to 2C respectively). The titanium dioxide greatly enhanced the opacity of the film.

### EXAMPLE 3A TO 3B

(Aluminium Voiding Agent)

Polyproplyene blends were made up containing the aluminium platelets 5 % Siberline ET2025 and 5% Siberline ST 210-30-El (Examples 3A and 3B resp.). These materials were stretched into film via the same method as described in Example 1. The resultant film was highly voided and had a highly reflective metallic appearance.

### EXAMPLE 4 TO 7

Four film variants Examples 4 to 7 were prepared as described in Example 1A above, except the mica was substituted with 10% of calcium carbonate (Pearl 70) and the film was produced with a thickness of around 35 micron. This effect of heat setting versus non heat setting and the effect of adding hard resin to the was tested for these films. When added the hard resin used was the mixed monomer resin described herein added to the polypropylene core at 10% concentration.

| | |
|---|---|
| Example 4 | No hard resin in core & non-heat set |
| Example 5 | No hard resin in core & heat set |
| Example 6 | Hard resin in core & non-heat set |
| Example 7 | Hard resin in core & heat set |

TABLE 1
Shrinkage data for Examples 4 to 7

| | No hard resin | | | | Hard resin | | | |
|---|---|---|---|---|---|---|---|---|
| | Ex 4 non-heat set | | Ex 5 heat set | | Ex 6 non-heat set | | Ex 7 heat set | |
| | % MD | % TD | % MD | % TD | % MD | % TD | % MD | % TD |
| Temp/° C. | shrinkage | shrinkage | shrinkage | shrinkage | shrinkage | shrinkage | shrinkage | shrinkage |
| 80 | 0.96 | 1.99 | 0 | 0 | 2.39 | 3.58 | 0.48 | 0 |
| 90 | 1.91 | 3.97 | 0.48 | 0 | 2.87 | 5.30 | 0.96 | −0.66 |
| 100 | 2.39 | 6.89 | 0.48 | 0 | 4.31 | 7.28 | 1.44 | −0.66 |
| 110 | 3.35 | 6.89 | 0.96 | 0 | 4.78 | 9.74 | 1.91 | −0.66 |
| 120 | 4.78 | 9.93 | 2.25 | 0 | 7.03 | 15.23 | 3.45 | −0.66 |
| 130 | 6.70 | 13.51 | 4.16 | 1.59 | 9.09 | 18.15 | 6.41 | 0.66 |

TABLE 2
Tensile data Examples 4 to 7

| | | Tensile | | Elongation | | Young's | |
|---|---|---|---|---|---|---|---|
| | | strength | | at break | | modulus | |
| | | | MD/TD | | MD/TD | | MD/TD |
| Sample | | MPa | ratio | % | ratio | MPa | ratio |
| Ex 5 Heat set | MD | 136.6 | 1.27 | 45.56 | 0.74 | 2342 | 1.15 |
| | TD | 107.7 | | 61.17 | | 2037 | |
| Ex 4 Non heat | MD | 142.1 | 1.17 | 33.65 | 0.48 | 2253 | 1.09 |
| set | TD | 121.7 | | 69.9 | | 2069 | |
| Ex 6 Hard resin | MD | 130.7 | 0.99 | 40.07 | 1.10 | 2530 | 0.97 |
| Non heat set | TD | 132.0 | | 36.5 | | 2621 | |
| Ex 7 Hard resin | MD | 136.8 | 1.24 | 56.64 | 0.76 | 2406 | 1.13 |
| Heat set | TD | 110 | | 74.73 | | 2135 | |

Examples 4 to 7 were also tested in a conventional handelometer test with the gap set to 20 mm. The Handelometer gives a figure which relates to stiffness in a specific direction (MD or TD). The sheet of film is placed in the Handelometer. A bar is then lowered down onto the film and pushes the film into a slot. The slot is aligned along the axis of the film (MD or TD). The machine measures the weight required to push the film into the slot.

TABLE 3
No hard resin

| | |
|---|---|
| Ex 4 non-heat set | Ex 5 heat set |

| MD g | TD g | MD g | TD g |
|---|---|---|---|
| 21.5 | 22.6 | 30.2 | 33.9 |

| | |
|---|---|
| MD/TD = 1.05 | MD/TD = 1.12 |

Hard resin

| | |
|---|---|
| Ex 6 non-heat set | Ex 7 heat set |

| MD g | TD g | MD g | TD g |
|---|---|---|---|
| 11.75 | 12.1 | 47.1 | 47.3 |

| | |
|---|---|
| MD/TD = 1.03 | MD/TD = 1.00 |

For comparison an analogous prior art film made on a sequential stenter machine was also tested with the handelometer to give the following results.

TABLE 4
Stenter film

| MD g | TD g |
|---|---|
| 8.1 | 13.2 |

MD/TD = 1.63

The handelometer results show conventional film produced on a sequential stenter have a MD/TD lie around 1.6 compared to the voided bubble film of the invention with MD/TD below 1.5. The closer the MD/TD figure is to 1 the more balanced the stiffness of the film.

Further films were prepared in an analogous method to that described in Example 1A or 2A above.

| Example | Voiding agent | Details (PP = polypropylene) |
|---|---|---|
| 8 | Mica | 20% in thick outer coat. |
| 9 | Mica | 15% in core with thick PP outer coat. |
| 10 | Mica | 20% in thick outer coat with white PP core. |
| 11 | Mica | 15% in core with white master-batch with |
| | | thick PP outer coat. |
| 12 | Spheriglass | 20% in thick outer PP coat with clear |
| | | PP core. |
| 13 | Spheriglass | 20% in thick PP coats with white PP core. |
| 14 | Spheriglass | 15% in core with thick clear outer PP coat. |
| 15 | Spheriglass | 15% in core along with white master-batch |
| | | with thick clear PP coats. |
| 16 | Silberline 1 | 5% in core with thick clear PP outer coat. |
| 17 | Pearl 2 | 20% of the calcium carbonate cavitating |
| | | master batch |
| 18 | Pearl 2 | 35% of the calcium carbonate cavitating |
| | | master batch |
| 19 | Pearl 70 | calcium carbonate cavitating master batch |
| 20 | Omyalene | calcium carbonate cavitating master batch |

TABLE 5
Film evaluation results

| Example | Opacity % | Volume/cm³ | Weight/g |
|---|---|---|---|
| 8 Mica coat | 8 | 4.68 | 4.30 |
| 9 Mica coat white core | 77 | 3.55 | 3.51 |
| 10 Mica core | 35 | 3.99 | 3.72 |
| 11 Mica/white core | 73 | 3.99 | 3.86 |
| 12 Spheriglass coat | 9 | 3.43 | 3.11 |
| 13 Spheriglass coat white core | 74 | 2.99 | 2.93 |
| 14 Spheriglass core | 74 | 5.11 | 3.84 |
| 15 Spheriglass/white core | 87 | 5.61 | 4.11 |
| 16 Pearl 2 (20%) | 24 | 3.99 | 3.85 |
| 17 Pearl 2 (35%) | 54 | 3.87 | 3.81 |
| 18 Pearl 70 | 67 | 5.24 | 3.90 |
| 19 Omyalene | 53 | 4.68 | 4.32 |
| 20 Silberline core | 53 | 3.81 | 3.02 |
| 21 Silberline lamination layer | — | 4.24 | 3.92 |

TABLE 6

| | | | Tensile | 1% secant | Young's | |
|---|---|---|---|---|---|---|
| | | Elongation | strength. | modulus | Modulus | Normalised |
| Sample | Orientation | at break/% | MPa | MPa | MPa | Stiffness |
| Ex 10 - Mica MB | TD | 73.72 | 164.7 | 2663 | 2644 | 1.518 |
| | MD | 91.12 | 143 | 2503 | 2511 | 1.628 |
| Ex 11 - Mica TiO2 WMB | TD | 66.45 | 170.8 | 2755 | 2668 | 1.524 |
| | MD | 89.37 | 145.2 | 2507 | 2412 | 1.628 |
| Ex 14 - Spheriglass | TD | 31.89 | 114.5 | 2090 | 2123 | 0.839 |
| | MD | 52.1 | 104.3 | 1860 | 1789 | 0.785 |
| Ex 15 - Spheriglass | TD | 44.36 | 87.39 | 1624 | 1622 | 0.414 |
| WMB 40% | MD | 53.02 | 122.8 | 1795 | 1549 | 0.969 |
| Ex 16 - Pearl 2 at 35% | TD | 75.27 | 144.8 | 2363 | 2134 | 1.567 |
| | MD | 87.82 | 144.8 | 2700 | 2624 | 1.751 |
| Ex 17 - Pearl 2 at 20% | TD | 75 | 183.1 | 2854 | 2630 | 1.458 |
| | MD | 84.23 | 153.6 | 2692 | 2588 | 1.892 |
| Ex 18 - Pearl 70 | TD | 50.98 | 115.8 | 2069 | 1992 | 0.466 |
| | MD | 65.15 | 95.1 | 1309 | 1098 | 0.466 |
| Ex 19 - Omyalene | TD | 52.56 | 116.1 | 2222 | 2242 | 1.31 |
| | MD | 75.64 | 129.7 | 2422 | 2414 | 1.367 |
| Ex 20 - Silberline | TD | 42.53 | 128.8 | 2395 | 2388 | 0.456 |
| | MD | 71.78 | 94.62 | 1519 | 1355 | 0.87 |

FIGS. 4 and 5 illustrate Example 14 (spheriglass without pigment). These pictures show film structures with varying degrees of voiding. It can be seen that the voiding agent particles have been forced to align with the long axes of the particles in the plane of the film. The shrinkages of these films produced in Examples 8 to 20 were very low. This is characteristic of thick laminated film.

IDR Trial of Examples 14 and 15

Some of these films were run at the end of an IDR (intermediate draw ratio trial). The films run during this trial were Ex 14 (spheriglass voiding agent without pigment) and Ex 15 (spheriglass voiding agent with titanium dioxide pigment). A stable bubble was achieved and a short mill roll of material was run off. This film can be slit in to reels suitable for coating. Properties of the film were measured as given below:

TABLE 7

| | | Thickness | Density |
|---|---|---|---|
| | Opacity % | microns | gcm⁻³ |
| Ex 14 (IDR) | 94 | 200 | 0.604 |

### EXAMPLES 22 TO 27

Six further film variants were produced with thickness around 35 micron by methods analogous to those described herein. This film can be used as a base film for coating to produce a voided coated film.

| | |
|---|---|
| Example 22 | Spheriglass core inner & outer melt coat clear |
| Example 23 | Spheriglass core inner melt coat white |
| Example 24 | Spheriglass core inner & outer melt coat white |
| Example 25 | Pearl 70 core inner & outer melt coat clear |
| Example 26 | Pearl 70 core Inner melt coat white |
| Example 27 | Pearl 70 core inner & outer melt coat white |

TABLE 8

| | Gloss inside | Gloss outside | Opacity |
|---|---|---|---|
| Example | of film % | of film % | % |
| Ex 22 - Spheriglass | 61.1 | 43.2 | 54-55 |
| Ex 23 - Spheriglass + white in | 24 | 47 | 58-61 |
| Ex 24 - Spheriglass + white | 22.7 | 22.7 | 65-70 |
| in & out | | | |
| Ex 25 - Pearl 70 | 41 | 35 | 81-82 |
| Ex 26 - Pearl 70 + white in | 28.5 | 34.9 | 73-75 |
| Ex 27 - Pearl 70 + white | 31.8 | 14.9 | 78-81 |
| in & out | | | |

### EXAMPLES 28 TO 36

Further examples were prepared as Example 2A according to the following table

TABLE 9

| Calcium | | | |
|---|---|---|---|
| carbonate | TiO2 | | |
| (Voiding agent) | 5% | 10% | 15% |
| 5% | Ex 28 | Ex 31 | Ex 34 |
| 10% | Ex 29 | Ex 32 | Ex 35 |
| 15% | Ex 30 | Ex 33 | Ex 36 |

The properties of these films were tested and the results are given in the following tables.

TABLE 10
Elongation at break/%

| Calcium | | | | |
|---|---|---|---|---|
| carbonate | | TiO2 | | |
| (Voiding agent) | Orientation | 5% | 10% | 15% |
| 5% | MD | 50 | 67 | 49 |
| | TD | 60 | 89 | 72 |
| 10% | MD | 63 | 43 | 43 |
| | TD | 82 | 53 | 52 |
| 15% | MD | 58 | 52 | 58 |
| | TD | 72 | 60 | 82 |

TABLE 11
Tensile strength MPa

| Calcium | | | | |
|---|---|---|---|---|
| carbonate | | TiO2 | | |
| (Voiding agent) | Orientation | 5% | 10% | 15% |
| 5% | MD | 148 | 178 | 149 |
| | TD | 102 | 140 | 134 |
| 10% | MD | 165 | 132 | 131 |
| | TD | 140 | 120 | 116 |
| 15% | MD | 154 | 162 | 157 |
| | TD | 133 | 123 | 118 |

TABLE 12
Young's modulus MPa

| Calcium | | | | |
|---|---|---|---|---|
| carbonate | | TiO2 | | |
| (Voiding agent) | Orientation | 5% | 10% | 15% |
| 5% | MD | 1391 | 1775 | 1893 |
| | TD | 1389 | 1525 | 1626 |
| 10% | MD | 1648 | 1839 | 1804 |
| | TD | 1408 | 1612 | 1690 |
| 15% | MD | 1695 | 1776 | 1779 |
| | TD | 1364 | 1483 | 1303 |

The MD /TD ratios for these properties can be seen to be within the desired values.

TABLE 13
Opacity & Gloss normalised for a 58 micron thick film (both %)

| Calcium | | | | |
|---|---|---|---|---|
| carbonate | | TiO₂ | | |
| (Voiding agent) | | 5% | 10% | 15% |
| 5% | Opacity | 65 | 80 | 83 |
| | Gloss | 38 | 34 | 35 |
| 10% | Opacity | 77 | 85 | 88 |
| | Gloss | 25 | 23 | 23 |
| 15% | Opacity | 83 | 91 | 93 |
| | Gloss | 27 | 26 | 21 |

TABLE 14
Thickness of film (microns)

| Calcium | | | |
|---|---|---|---|
| carbonate | TiO₂ | | |
| (Voiding agent) | 5% | 10% | 15% |
| 5% | 83 | 83 | 82 |
| 10% | 94 | 90 | 88 |
| 15% | 110 | 122 | 113 |

TABLE 15
Density (g/cm³)

| Calcium | | | |
|---|---|---|---|
| carbonate | TiO₂ | | |
| (Voiding agent) | 5% | 10% | 15% |
| 5% | 0.67 | 0.70 | 0.72 |
| 10% | 0.62 | 0.65 | 0.66 |
| 15% | 0.55 | 0.53 | 0.56 |

1. A simultaneously oriented polyolefinic film comprising particles in at least one layer thereof, said particles incompatible with said layer to cause the initiation of voids therein when the cast polyolefin is stretched simultaneously in both the MD and TD, and where the particles comprise:
(i) particles having a mean aspect ratio x/y of at least 2, and a mean size of the longest particle dimension greater than about 3 microns; and/or
(ii) particles having a mean aspect ratio of about 1, with a narrow size distribution, a mean particle size of from about 3 to about 10 microns, and which are substantially free of particles above about 12 microns in size.

2. The film as claimed in claim 1, wherein the ratio of at least one of the following properties measured in the MD with respect to TD is:
(a) tensile strength of above 0.5;
(b) elongation at break of below 2.0;
(c) Young's modulus of at least 0.7; and/or
(d) shrinkage of at least 0.45, the TD shrinkage being other than zero.

3. A The simultaneously oriented polyolefinic film comprising particles therein which are incompatible with the polyolefin and which cause the initiation of voids in the film when the cast polyolefin is stretched wherein the ratio of at least one of the following properties measured in the MD with respect to TD is:
(a) tensile strength of above 0.5;
(b) elongation at break of below 2.0;
(c) Young's modulus of at least 0.7; and/or
(d) shrinkage of at least 0.45 the TD shrinkage being other than zero.

4. A The film according to either claim 2 or 3, in which at least one of the MD/TD ratios of the properties (a) to (d) is substantially balanced optionally about 1.0.

5. The film according to claim 1 or 3, in which the polyolefin is polypropylene.

6. The film according to claim 1 or 3 which has a density of less than about 0.85 g/cm³.

7. The film according to claim 1 or 3 which has a ratio of shrinkage of the film MD/TD ratio is less than about 1.

8. The film according to claim 1 or 3 which has a ratio of the tensile strength of the film MD/TD ratio from about 1.0 to about 1.5.

9. The film according to claim 1 or 3 which the elongation to break of the film MD/TD ratio is from about 0.5 to about 0.9.

10. The film according to claim 1 or 3 which the Young's modulus of the film MD/TD ratio is greater than about 1.0.

11. The film according to claim 1 or 3 in which the voiding agent is selected from the group consisting of mica, aluminum platelets; micro-spherical glass beads, titanium dioxide and calcium carbonate.

12. The film according to claim 1 or 3 in which the voiding agent has an aspect ratio of at least about 5.

13. A The film according to claim 1 or 3 which further comprises a pigment, optionally titanium dioxide preferably in an amount of at least 5%, optionally about 10%, by weight.

14. The film according to claim 1 or 3, in which the voiding agent has at least one linear dimension less than about 2 microns.

15. The film according to claim 1 or 3, which has an unlaminated thickness of at least 50 microns.

16. A method of making a film according to claim 1 or 3 using a conventional blown double bubble process and/or a simultaneously oriented stenter machine (e.g. LISM).

17. A film obtained and/or obtainable by a method as claimed in claim 16.

18. A label, artificial paper and/or printed article comprising a film as claimed in claim 1 or 3.

19. A method of manufacturing a film as claimed in claim 1 or 3, which comprises using a voiding agent whilst simultaneously orientating the film.

20. (Cancelled)

21. The film as claimed in claim 1, wherein the mean size of the longest particle dimension is above 6 microns and the mean particle size is about 6 microns.
